(19) United States
(12) Patent Application Publication
(10) Pub. No.: US 2016/0285494 A1
(43) Pub. Date: Sep. 29, 2016

(54) RF SIGNAL TRANSMISSION IN BATTERY PACK

(71) Applicant: Motorola Mobility LLC, Chicago, IL (US)

(72) Inventors: Michael J. Lombardi, Lake Zurich, IL (US); Joseph L. Allore, Mundelein, IL (US); Natalie J. Stevens, Spring Grove, IL (US)

(21) Appl. No.: 14/669,804

(22) Filed: Mar. 26, 2015

(51) Int. Cl. H04B 1/3883

(52) U.S. Cl. CPC H04B 1/3883

(57) ABSTRACT

A battery packaging technique for a portable communications device encloses two or more RF transmission lines under or within a metallic side seal of a battery pack of the device. The RF transmission lines are controlled in this manner during assembly and are well-constrained across the width and thickness of the pack, but at the same time are free to slide along the length of the battery to allow for easy assembly to the device. The metallic side seal may comprise a metal foil, and in an embodiment the RF transmission lines are color-coded so that they can be accurately assembled to the finished device.

### TECHNICAL FIELD

The present disclosure is related generally to mobile device configuration, and, more particularly, to a system and method for enabling passage of a radio frequency (RF) signal along a battery pack of a portable communication device.

### BACKGROUND

The widespread appeal and adoption of cellular phones is due, in large part, to the miniaturization of electronic components. The contemporaneous spread of high quality cellular infrastructure contributed to popularity of such devices. However, a compact and capable device connected to a high quality cellular infrastructure still needs one more thing to function—a power source.

In a mobile device, that power source is almost always a battery. Indeed, new battery technologies have spurred growth in many sectors including the portable device market. High capacity batteries enable longer operating times between recharging. In a modern portable communications device, the battery weight and size make up a significant percentage of the total device weight and size.

Given this, it is sometimes becomes necessary to route data and signal carriers around or over the battery during the manufacture of a device. When these signals are RF signals, it is typical to use RF transmission lines in the form of coaxial cables or flexible printed circuits to shield and convey the signals. However, the free use of coaxial cables or flexible printed circuits consumes valuable space within the device and leads to a reduction in the allowable width of the battery, while creating difficulty in consistently assembling the device. A well-shielded, consistently assembled design for RF signal transmission along a battery is needed if the allowable size of the battery is to be maximized.

While the present disclosure is directed to a system that can eliminate certain shortcomings discussed in this Background section, it should be appreciated that such a benefit is neither a limitation on the scope of the disclosed principles nor of the attached claims, except to the extent expressly noted in the claims. Additionally, the discussion of technology in this Background section is reflective of the inventors' own observations, considerations, and thoughts, and is in no way intended to accurately catalog or comprehensively summarize the art in the public domain.

As such, the inventors expressly disclaim this section as admitted or assumed prior art with respect to the discussed details. Moreover, the identification herein of a desirable course of action reflects the inventors' own observations and ideas, and should not be assumed to indicate an art-recognized desirability.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a simplified schematic of an example device with respect to which embodiments of the presently disclosed principles may be implemented;

FIG. 2 is a schematic view within a portable communications device in accordance with an embodiment of the disclosed principles;

FIG. 3 is a schematic view in accordance with FIG. 2, further including an installed battery configured in keeping with an embodiment of the disclosed principles;

FIG. 4 is a back view of a battery configured in accordance with an embodiment of the disclosed principles;

FIG. 5 is a cross-sectional view of a battery and housing accordance with an embodiment of the disclosed principles;

FIG. 6 is a is a cross-sectional view of a battery and housing further including two encapsulated coaxial cables in accordance with an embodiment of the disclosed principles; and

FIG. 7 is a flow chart showing a process for constructing a device in accordance with an embodiment of the disclosed principles;

### DETAILED DESCRIPTION

Before presenting a full discussion of the disclosed principles, an overview of certain embodiments is given to aid the reader in understanding the later discussion. In an embodiment of the disclosed principles, a new battery packaging technique for portable communications devices is provided in which two or more RF transmission lines are wrapped under or within a metallic side seal of a battery pack of the device. In one embodiment, the RF transmission lines are coaxial cables. The coaxial cables are controlled by the side seal during assembly and are well-constrained across the width and thickness of the pack, but at the same time are free to slide along the length of the battery to allow for easy assembly to the device. The metallic side seal may comprise a metal foil, and in an embodiment the coaxial cables are color-coded so that they can be accurately assembled to the finished device.

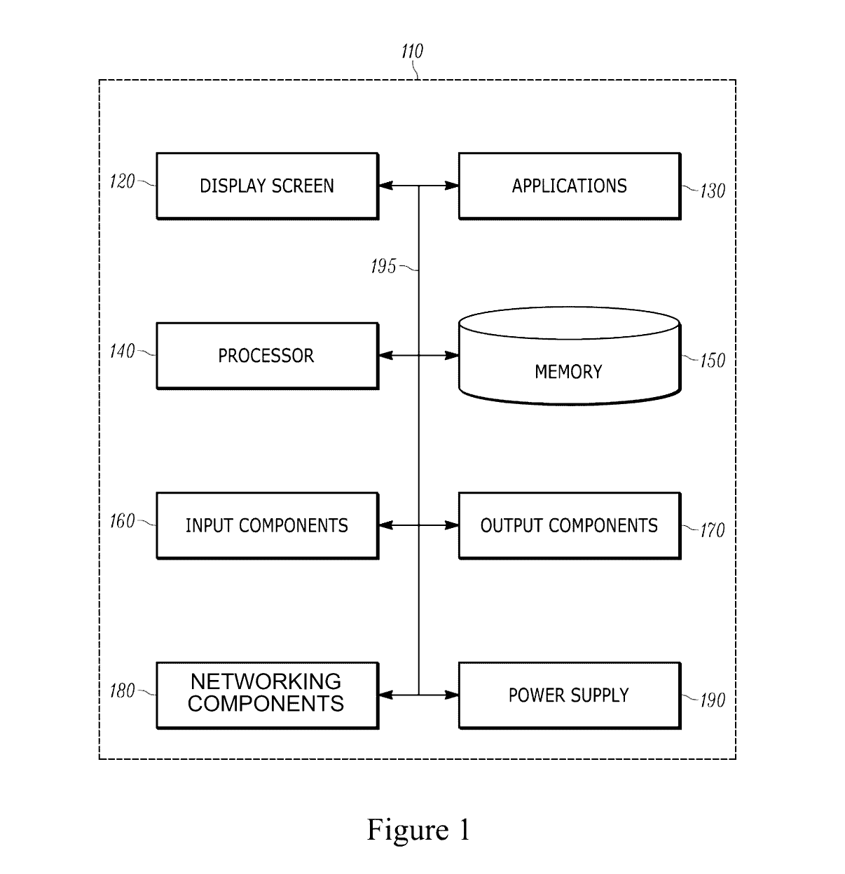

With this overview in mind, and turning now to a more detailed discussion in conjunction with the attached figures, the structures and techniques of the present disclosure are shown being implemented in a suitable portable device environment. The following device description is based on embodiments and examples within which the disclosed principles may be implemented and should not be taken as limiting the claims with regard to alternative embodiments that are not explicitly described herein. Thus, for example, while FIG. 1 illustrates an example mobile device within which embodiments of the disclosed principles may be implemented, it will be appreciated that other device types may be used, including but not limited to personal computers, tablet computers and other devices.

The schematic diagram of FIG. 1 shows an exemplary component group 110 forming an environment within which aspects of the present disclosure may be implemented. In particular, the component group 110 includes exemplary components that may be used in a device wherein the described shielding technique is implemented. It will be appreciated that additional or alternative components may be used in a given implementation depending upon user preference, component availability, price point, and other considerations.

In the illustrated embodiment, the components 110 include a display screen 120 (e.g., a touch screen), applications (e.g., programs) 130, a processor 140, a memory 150, one or more input components 160 such as speech and text input facilities, and one or more output components 170 such as text and audible output facilities, e.g., one or more speakers.

The processor 140 may be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device. Such functions may include, for example, interaction among various internal components and storage and retrieval of applications and data to and from the memory 150.

Further with respect to the applications 130, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device having component group 110 may include software and hardware networking components 180 to allow communications to and from the device. Such networking components 180 will typically provide wireless networking functionality, although wired networking may additionally or alternatively be supported. In an embodiment, the networking components 180 include a WiFi transceiver, and a WiFi antenna.

Notably for purposes of the disclosed principles, a battery 190 is included for providing power to the device and its components 110. All or some of the internal components 110 communicate with one another by way of one or more shared or dedicated internal communication links 195, such as an internal bus.

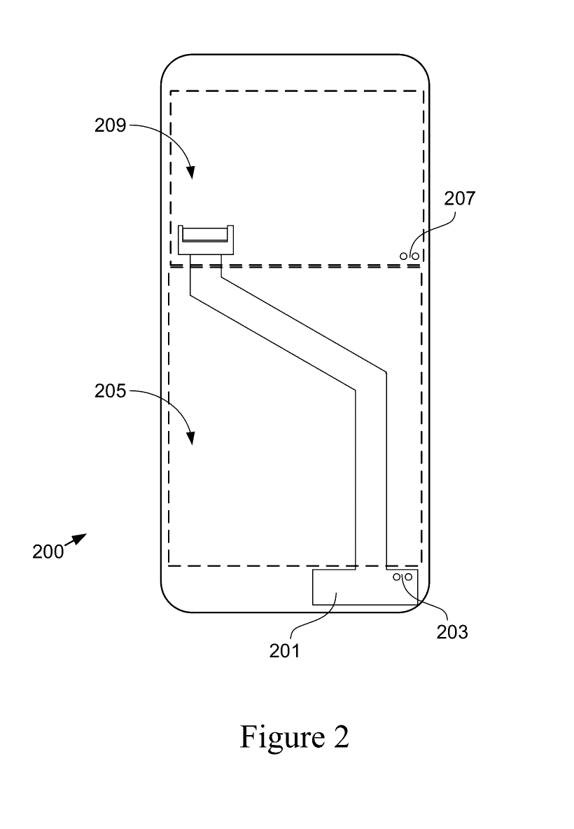

Turning to FIG. 2, this figure presents a schematic view within a portable communications device 200 in accordance with an embodiment of the disclosed principles. The portable communications device 200 includes a flexible printed circuit (FPC) 201 which carries electrical signals from the bottom of the device to the top beneath a battery area 205, which will contain the device battery when the device 200 is fully assembled.

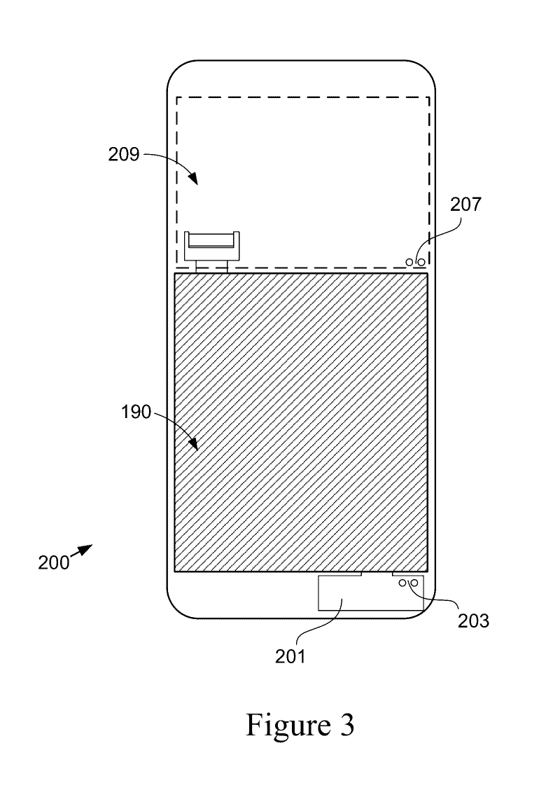

A first set of coaxial connectors 203 are located on the FPC 201 and a second set of coaxial connectors 207 are located on a printed circuit board (PCB) within a PCB region 209 located above the battery area 205. As can be seen in FIG. 3, when a battery 190 is installed in the battery area 205, any coaxial cables linking the first set of coaxial connectors 203 to the second set of coaxial connectors 207 will traverse over or next to the battery 190 and will need to be precisely located and installed.

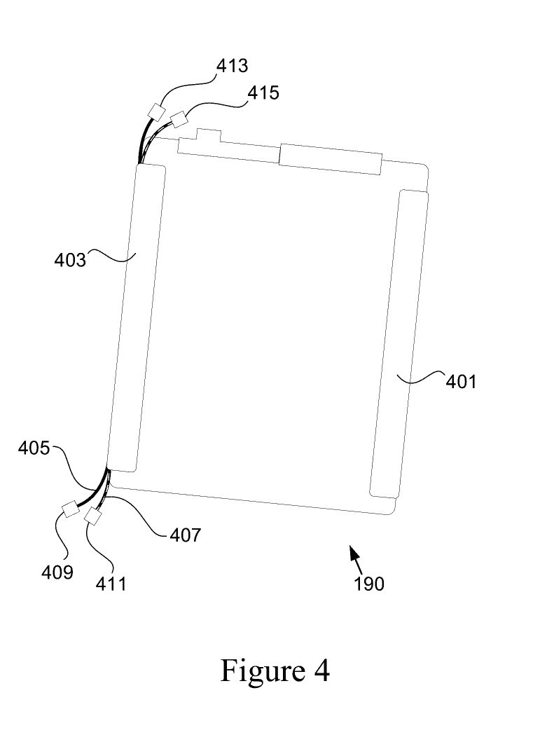

In an embodiment of the disclosed principles, the battery itself is configured to guide and shield the coaxial cables linking the first set of coaxial connectors 203 to the second set of coaxial connectors 207. An example battery configuration is shown in FIG. 4. In this figure, the battery 190 includes one or more side seals 401, 403, which are typically adhesive foil tabs wrapped around from the opposite side of the battery 190 and adhered to the visible side.

In the illustrated embodiment, one tab or label 403 wraps a pair of coaxial cables 405, 407 to the battery 190 before being adhered to the visible side of the battery 190. While the coaxial cables 405, 407 are shielded along much of their length, the respective bottom ends 409, 411 of the cables 405, 407 emerge at the bottom of the battery 190, and the respective top ends 413, 415 emerge from the top of the battery 190. In this way, when the battery 190 is installed in the device in a configuration as shown in FIGS. 3-4, the cable ends 405, 407, 409, 411 are ready to be connected, e.g., via connectors 203 and 207.

In an embodiment, while the portions of the cables 405, 407 under the tab 403 are constrained laterally, the cables 405, 407 remain free to move under the tab in the direction along the battery 190. Moreover, as indicated in FIG. 4, the cables 405, 407 may be distinguished from one another by different coloring or patterning. Although two cables 405, 407 are shown in FIG. 4, it will be appreciated that a greater or lesser number of cables may be routed under the tab along the battery 190 depending upon implementation desires or requirements. Moreover, although FIG. 4 shows cables 405, 407 routed along one side of the battery 190, in an alternate embodiment, cables are routed along both sides of the battery 190.

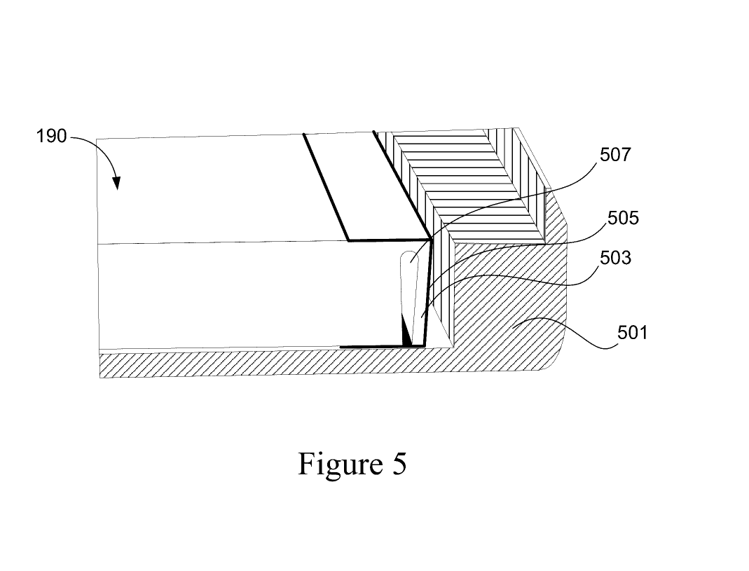

Continuing with the example configuration of FIG. 4, FIG. 5 is a cross-sectional view of the battery 190 installed in a housing 501, with no cables installed along the battery 190. The battery wrapper 503 extends beyond the edge of the battery 190, before wrapping downward. The battery wrapper 503 is constructed using a thin metal foil. Tape 505 wraps around the edge of the battery 190 and closes the battery wrapper 503, leaving a slight cavity 507. The tape 505 may be conductive or non-conductive.

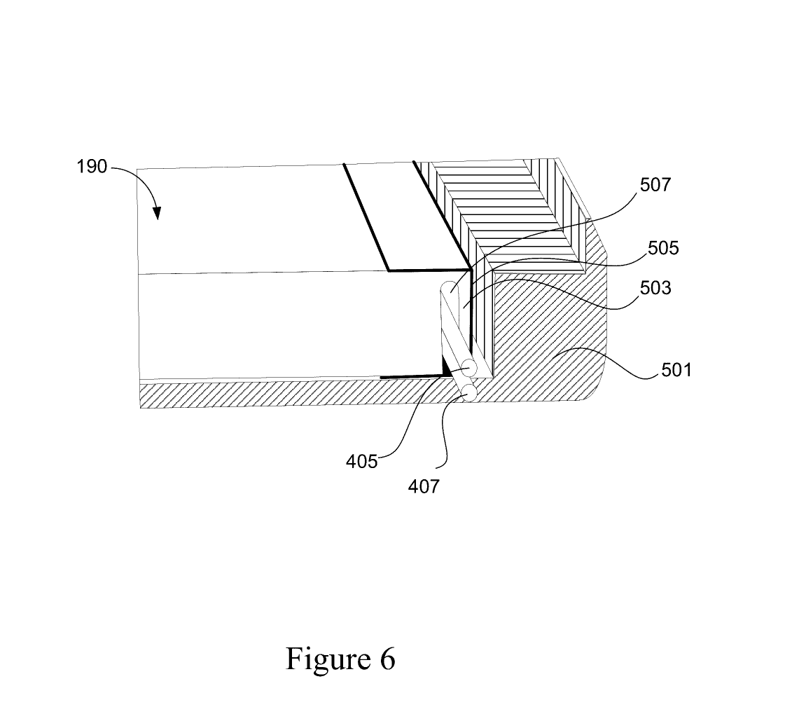

When cables are instead included, the resulting configuration appears as shown in FIG. 6. As can be seen, the cables 405, 407 extend and are retained between the battery 190 and the battery wrapper 503, and the battery wrapper 503 is maintained in position by tape 505. Although the cables 405, 407 may be pulled or pushed along the battery to adjust their length on the top and bottom of the battery 190, the cables 405, 407 cannot be separated from the battery laterally. In this way, when the battery 190 is installed in the device housing 501, the cables 405, 407 are already substantially prepositioned laterally and approximately prepositioned vertically.

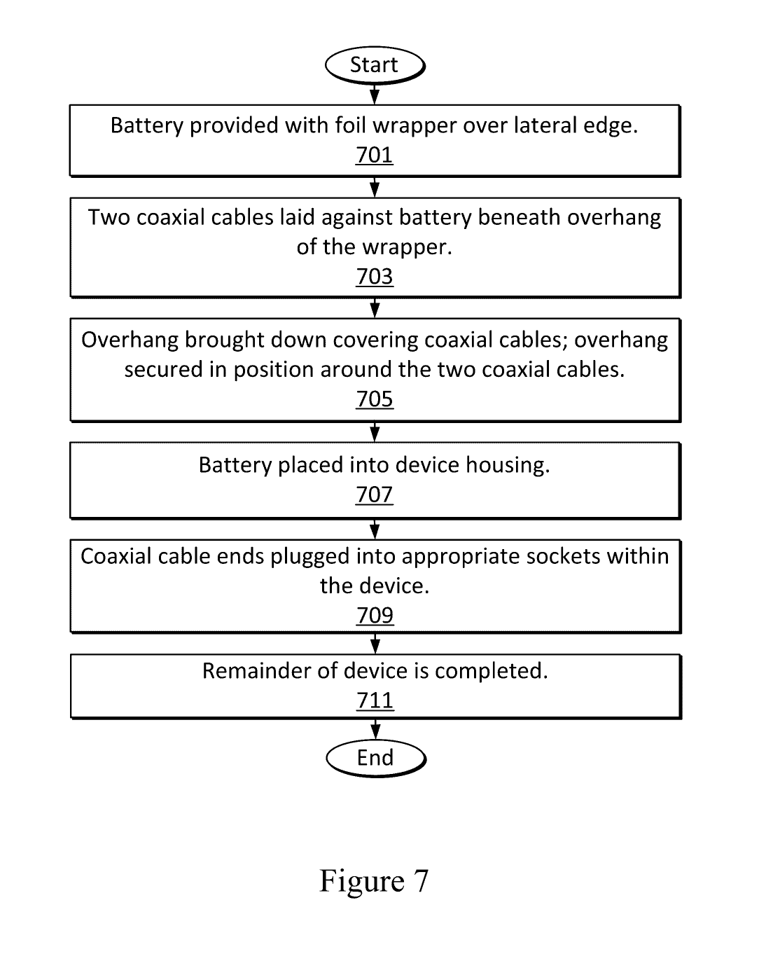

Although various processes may be used to construct a battery as described herein or a device having a battery as described herein, FIG. 7 is a flow chart showing an example process 700 for such construction. At stage 701 of the process 700, a battery having a foil wrapper overhanging its lateral edge is provided. Further, in this example, two coaxial cables are laid alongside and against the battery, one on top of the other, beneath the overhang of the wrapper at stage 703.

At stage 705, the overhang of the wrapper is brought down to cover the two coaxial cables against the battery, and the overhang is secured in position around the two coaxial cables by a tape, tab or other fixative measure. In this configuration, ends of the cables are extending out from under the secured wrap at the top and bottom of the battery. The battery so prepared is then placed into the device housing at stage 707, and the coaxial cable ends are plugged into appropriate sockets within the device at stage 709. The remainder of the device may then be finished at stage 711.

It will be appreciated that a system and method for antenna and transceiver configuration for a modular portable device has been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A battery assembly for a portable electronic device, the battery assembly comprising:
a battery having a side, and a side seal overhanging the side;
at least one radio frequency (RF) transmission line with a connection point at each end, the at least one RF transmission line being located along the side of the battery and the side seal wrapping down over the at least one RF transmission line; and
a tab secured over the side seal to hold it in place over the at least one RF transmission line.

2. The battery assembly in accordance with claim 1, wherein the tab comprises a label.

3. The battery assembly in accordance with claim 1, wherein the at least one RF transmission line is free to move along the side of the battery.

4. The battery assembly in accordance with claim 1, wherein the battery comprises a battery cell contained in a metal foil pouch which forms the side seal.

5. The battery assembly in accordance with claim 1, wherein the at least one RF transmission line comprises at least one coaxial cable.

6. The battery assembly in accordance with claim 5, wherein the at least one coaxial cable comprises two or more coaxial cables.

7. The battery assembly in accordance with claim 6, wherein the two or more coaxial cables are colored to visually distinguish them from one another.

8. A method of making a battery assembly for a portable electronic device, the method comprising:
constructing a battery having a side and a side seal overhanging the side;
placing at least one RF transmission line with a connection point at each end along the side of the battery;
wrapping the side seal down over the at least one RF transmission line; and
securing a tab over the side seal to hold it in place over the at least one RF transmission line.

9. The battery assembly in accordance with claim 8, wherein the tab comprises a label.

10. The battery assembly in accordance with claim 8, wherein the at least one RF transmission line is free to move along the side of the battery.

11. The battery assembly in accordance with claim 8, wherein the battery comprises a battery cell contained in a metal foil pouch which forms the side seal.

12. The battery assembly in accordance with claim 8, wherein the at least one RF transmission line comprises at least one coaxial cable.

13. The battery assembly in accordance with claim 12, wherein the at least one coaxial cable comprises two or more coaxial cables.

14. The battery assembly in accordance with claim 13, wherein the two or more coaxial cables are colored to visually distinguish them from one another.

15. A portable electronic device comprising:
a device housing;
two or more electronic components within the device housing, each having at least one socket for receiving an RF transmission line connector;
a battery having a side, and a side seal overhanging the side;
at least one RF transmission line with a connection point at each end, the at least one RF transmission line being located along the side of the battery and the side seal wrapping down over the at least one RF transmission line; and
a tab secured over the side seal to hold it in place over the at least one RF transmission line, wherein when the battery is installed in the device housing, the at least one RF transmission line is located to electrically connect the two or more electronic components within the device housing via the at least one socket on each of the two or more electronic components.

16. The portable electronic device in accordance with claim 15, wherein the tab comprises a label.

17. The portable electronic device in accordance with claim 15, wherein the at least one RF transmission line is free to move along the side of the battery.

18. The portable electronic device in accordance with claim 15, wherein the battery is comprised of a battery cell contained in a metal foil pouch which forms the side seal.

19. The portable electronic device in accordance with claim 15, wherein the at least one RF transmission line comprises at least one coaxial cable.

20. The portable electronic device in accordance with claim 19, wherein the at least one coaxial cable comprises two or more coaxial cables that are visually distinct from one another.
